(19) United States
(12) Patent Application Publication
(10) Pub. No.: US 2005/0099500 A1
(43) Pub. Date: May 12, 2005

(54) Image processing apparatus, network camera system, image processing method and program

(75) Inventor: Takao Fujita, Kanagawa (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/985,191

(22) Filed: Nov. 10, 2004

(30) Foreign Application Priority Data
Nov. 17, 2003 (JP) 2003-386481
Nov. 18, 2003 (JP) 2003-387882
Nov. 11, 2003 (JP) 2003-380733
Aug. 18, 2004 (JP) 2004-238444

(51) Int. Cl. H04N 5/225

(52) U.S. Cl. 348/207.99

(57) ABSTRACT

In a network camera system, a camera unit detects a change in circumstances surrounding the camera unit. In response to detection of the change, the camera unit captures an image. Then, the camera unit extracts, from the captured image, a partial image corresponding to an area in which the change in circumstances occurred. The camera unit transmits the extracted partial image to a server unit.

### CROSS REFERENCE TO RELATED APPLICATIONS

This application claims priority from Japanese Patent Applications No. 2003-386481 filed Nov. 17, 2003, No. 2003-387882 filed Nov. 18, 2003, No. 2003-380733 filed Nov. 11, 2003 and No. 2004-238444 filed Aug. 18, 2004, which are hereby incorporated by reference herein.

### BACKGROUND OF THE INVENTION

1. Field of the Invention

The present invention relates to the field of processing of images captured by a camera, and, more particularly, to an image processing apparatus, a network camera system, an image processing method and a program for enabling an image captured by a camera to be displayed by a display device that is connected to the camera via a network.

2. Description of Related Art

With the recent popularity and high-speed technology of the Internet and intranets, information transmission of still images and moving images via a network has become commonplace. For such information transmission, a network camera system has been put on the market, which is capable of capturing a surrounding image in real time and which allows the captured image to be displayed on a display device via the network so as to be viewable by a remote user. One example of the network camera system is WebView Livescope® System using Network Camera Server VB150 produced by Canon® Inc.

The network camera system typically includes a camera unit, a camera server and a display unit. The camera unit is controllable for panning, tilting and zooming in response to commands received from the user side. The camera server distributes images captured by the camera unit over the network. The display unit is connected to the network, which may be a personal computer. The network camera system thus enables a user on the user side of the display unit to view an image acquired at a remote place where the camera unit is located, and to control the operation of the camera unit for capturing the image.

There is a known technology for generating a panoramic image or normal image from an image captured using a wide-angle optical system or omnidirectional image-capture system, such as a fish-eye lens or solid-of-revolution mirror, and for allowing a user to view the panoramic image or normal image via a network.

For example, in the article entitled “Telepresence by Real-time View-dependent Image Generation from Omnidirectional Images”, by Y. Onoe, K. Yamazawa, N. Yokoya, and H. Takemura, in Technical Report of the Institute of Electronics, Information and Communication Engineers, PRMU97-20, May 1997, there is a disclosure of a telepresence system for transmitting an omnidirectional image captured using a solid-of-revolution hyperbolical mirror to a remote user and for generating a perspective projection image corresponding to the visual line of the user. In addition, in U.S. Pat. No. 6,043,837, assigned to Be Here Corporation, there is a disclosure of a method for transmitting a designated fan-like partial area of an omnidirectional image and for transforming the fan-like area to a rectangular area so as to be displayed on the user side.

FIGS. 20A to 20D illustrate an example of the construction of a solid-of-revolution mirror 2005. FIG. 20A is a schematic diagram showing the appearance of the solid-of-revolution mirror 2005. The solid-of-revolution mirror 2005 includes a mirror portion 2001, a glass tube portion 2002 supporting the mirror portion 2001, a camera coupling portion 2003 having a screw thread for mounting on a camera, and a black needle portion 2004. The section of the mirror portion 2001 is in the form of a circular arc, parabola, hyperbola, or the like. The details of the example of the construction of the solid-of-revolution mirror 2005 are disclosed in Japanese Laid-Open Patent Application No. Hei 11-174603.

FIG. 20B is a schematic diagram illustrating the principle of omnidirectional image capturing by a conventional network camera system, in which the solid-of-revolution mirror 2005 is mounted on a camera 2006. A ray of light emerging from a point P (2009) on object space reflects from the mirror portion 2001 of the solid-of-revolution mirror 2005, passes through a lens 2007 and reaches a CCD (charge-coupled device) plane 2008, as indicated by a path 2010. As a result, when image capturing is performed with the camera 2006 facing vertically upward, such an omnidirectional image as shown in FIG. 20C is obtained.

At the center of the omnidirectional image shown in FIG. 20C, an image of the black needle portion 2004 exists as indicated by a circle 2011. On the outer side of the circle 2011, an image 2012 of 360 degrees around exists up to the outer circumference of the solid-of-revolution mirror 2005. Further, on the outer side of the image 2012, an image 2013 exists. This image 2013 results from rays of light directly entering the camera 2006 without reflection from the solid-of-revolution mirror 2005 and from rays of light from the bottom surface of the solid-of-revolution mirror 2005. The illustration of FIG. 20B omits ray of light directly entering the camera 2006, because the presence or absence of such rays is irrelevant to the present invention. There are a variety of solid-of-revolution mirrors, as described in the article entitled “Research Trend of Omnidirectional Vision”, by Yagi, in Computer Vision and Image Media, Vol. 125, pp. 147-160. For example, one not having the black needle portion 2004, one employing a different method for holding a mirror portion, etc.

The omnidirectional image shown in FIG. 20C can be converted into a panoramic image 2014 as shown in FIG. 20D. This conversion can be done by defining the center of an omnidirectional image and rearranging concentrically-existing points of the omnidirectional image in the horizontal direction of a rectangular area. Furthermore, the corresponding relationship between points on object space and points on an omnidirectional image when using a solid-of-revolution mirror is described in detail in Japanese Laid-Open Patent Application No. Hei 06-295333. Thus, a panoramic image can also be constructed by inversely projecting an omnidirectional image onto a cylindrical surface provided in object space. A normal image can be constructed by extracting a desired view portion from the panoramic image, or by defining an image plane on object space and projecting points of the omnidirectional image onto the image plane. Such a method of generating a panoramic image is described in detail in a variety of prior art documents and is, therefore, omitted from the following discussion.

In conventional network camera systems in which the performance of a display unit, such as a mobile phone or a portable terminal, is insufficient or the performance of a network is insufficient, it is very difficult for a user to understand which area of a captured image transmitted from a camera unit is changing.

### SUMMARY OF THE INVENTION

The present invention is directed to overcoming the above-described drawbacks. The present invention provides an image processing apparatus, a network camera system, an image processing method and a program, for enabling a user to adequately understand a change in circumstances of a captured image even in a system in which the performance of a display unit is insufficient or the performance of a network is insufficient.

In an aspect of the present invention, there is provided an image processing apparatus for processing an image captured by a camera. The image processing apparatus includes: a detection device for detecting a change in circumstances surrounding the camera; an acquisition device for acquiring an image captured by the camera in response to detection by the detection device; an extraction device for extracting, from the captured image, a partial image corresponding to an area in which the change in circumstances has occurred; and an output device for outputting the partial image extracted by the extraction device.

The above and further features and advantages of the present invention will become apparent to those skilled in the art upon reading of the following detailed description of embodiments thereof when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an example of the hardware construction of a network camera system according to a first embodiment of the invention.

FIG. 2 is a block diagram showing an example of the hardware construction of a network camera system that includes a wireless viewer.

FIG. 3 is a perspective view showing an example of the arrangement of a camera unit and a server unit.

FIG. 4 is a perspective view showing another example of the arrangement of a camera unit and a server unit.

FIG. 5 is a block diagram showing in detail the construction of the camera unit and the server unit shown in FIG. 1.

FIGS. 6A and 6B are diagrams illustrating the arrangement of sensors and the detection angle thereof.

FIG. 7 is a flow chart illustrating the operation of the network camera system according to the first embodiment.

FIGS. 8A to 8C are diagrams illustrating an extraction process according to the first embodiment.

FIG. 9 is a block diagram showing in detail the construction of a camera unit that is connectable to a wireless public network.

FIG. 10 is a flow chart illustrating the operation of a network camera system according to a second embodiment of the invention.

FIGS. 11A to 11C are diagrams illustrating an extraction process according to the second embodiment.

FIG. 12 is a block diagram showing in detail the construction of a viewer according to a third embodiment of the invention.

FIG. 13 is a diagram illustrating an extraction process according to the third embodiment.

FIG. 14 is a flow chart illustrating the operation of a network camera system according to the third embodiment.

FIG. 15 is a diagram illustrating image display on a viewer.

FIGS. 16A to 16G are diagrams illustrating the details of superimposition of images according to the third embodiment.

FIG. 17 is a flow chart illustrating the operation of a network camera system according to a sixth embodiment of the invention.

FIG. 18 is a diagram illustrating an extraction process according to the sixth embodiment.

FIGS. 19A, 19B, 19C, 19D, 19E, 19F and 19G are diagrams illustrating the details of superimposition of images according to the sixth embodiment.

FIGS. 20A to 20D are illustrations showing a conventional network camera system.

### DETAILED DESCRIPTION OF THE EMBODIMENTS

Embodiments of the invention will be described in detail below with reference to the drawings.

### First Embodiment

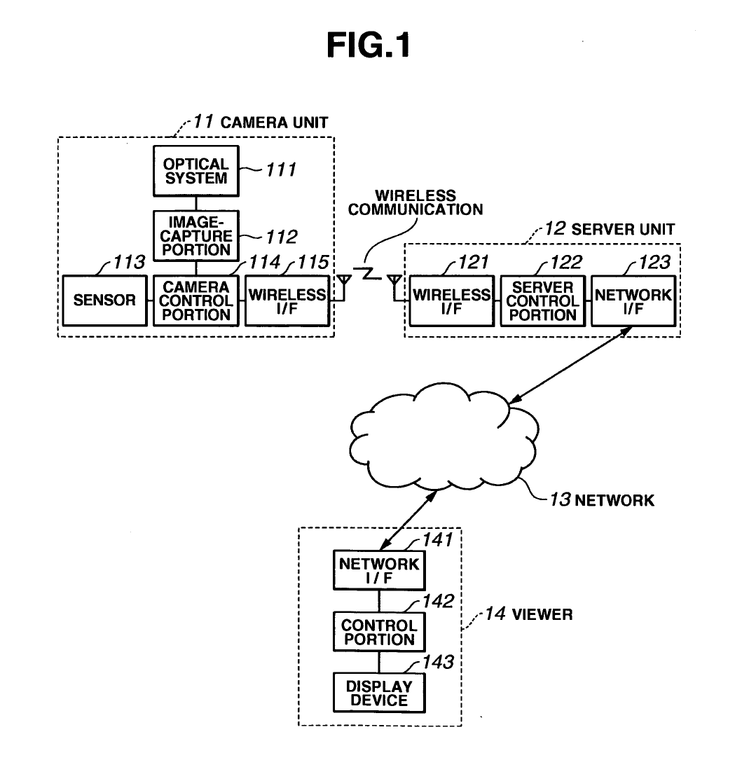

FIG. 1 is a block diagram showing an example of the hardware construction of a network camera system according to a first embodiment of the invention. The network camera system includes a camera unit 11, a server unit 12, a network 13 and a viewer 14. The camera unit 11 includes an optical system 111, an image-capture portion 112, a sensor 113, a camera control portion 114 and a wireless interface (I/F) 115. The server unit 12 includes a wireless I/F 121, a server control portion 122 and a network I/F 123. The viewer 14 includes a network I/F 141, a control portion 142 and a display device 143.

The optical system 111 is used for capturing an image. The sensor 113 detects a change in circumstances surrounding the camera unit 11 and a direction in which an area where such a change has occurred exists. The image capture portion 112 includes a CCD (charge-coupled device) or a CMOS (complementary metal oxide semiconductor) image sensor. The camera control portion 114 performs a camera control operation including focusing, aperture setting, white balance, shutter release, etc., processing of a signal from the sensor 113, compression of image data from the image capture portion 112, and extraction of a partial image corresponding to an area where a change has occurred. The wireless I/F 115 is adapted for transmitting, through wireless communication, the extracted partial image to the server unit 12.

When the sensor 113 detects a change in circumstances surrounding the camera unit 11 and a direction in which an area where such a change has occurred exists, the image capture portion 112 and the camera control portion 114 capture a surrounding image formed by the optical system 111. The camera control portion 114 then extracts, from the captured image, a partial image located in the direction detected by the sensor 113 and transmits the extracted partial image to the server unit 12 via wireless communication. The server unit 12 transmits the received image data to the network 13. The network 13 may be the Internet, an intranet or the like. The viewer 14 receives the image data from the network 13 and displays an image on the display device 143. The viewer 14 can be located anywhere as long as it is connectable to the network 13. Thus, a remote user can find a change in circumstances at the place where the camera unit 11 is located.

Communication between the camera unit 11 and the server unit 12 is performed via wireless communication. Thus, the camera unit 11 is separated from the server unit 12, the place of which is restricted due to connection to the network 13, which usually employs wire communication. Accordingly, the camera unit 11 can be freely placed at any position where the user wishes to monitor. Depending on the application or usage of the system, communication between the camera unit 11 and the server unit 12 may be performed thorough wire communication by cables or through direct connection.

As one example of the wireless communication method, there is the Bluetooth standard employing spread spectrum communication technology, which is a low-cost communication method developed for consumer use. The Bluetooth standard uses spread spectrum modulation of frequency-hopping of the 2.4 GHz band and is suited for transmitting data of about 700 kbps at an interval of 10-100 m. The Bluetooth standard enables a small-sized, low-cost and low-power-consumption circuit element, which can, therefore, be incorporated into a small-sized apparatus.

The optical system 111 enables a wide range of surveillance with a single camera unit by employing a fish-eye lens having an angle of view of about 180 degrees or a solid-of-revolution mirror having an angle of view of 360 degrees on one side and reflecting an omnidirectional image. An optical system for use in an ordinary camera can be used as the optical system 111. In the following discussion, an omnidirectional optical system using a solid-of-revolution mirror is taken as an example of the optical system 111.

In the server unit 12, the wireless I/F 121 receives, through wireless communication, image data from the camera unit 11. The server control portion 122 processes the received image data to correct distortion of a captured image caused by the solid-of-revolution mirror of the camera unit 11 and performs a network sever function. The network I/F 123 transmits distortion-corrected, rectangular image data to the network 13.

As an example of the network server function, WebView Protocol produced by Canon® Inc. is usable with WWW (World Wide Web) browsers widely used in the Internet.

The viewer 14 receives rectangular image data from the server unit 12 via the network 13 and displays an image represented by the image data on the display device 143. In the example shown in FIG. 1, the viewer 14 is connected directly to the network 13 through wired connection. However, the first embodiment is not limited to such a network connection.

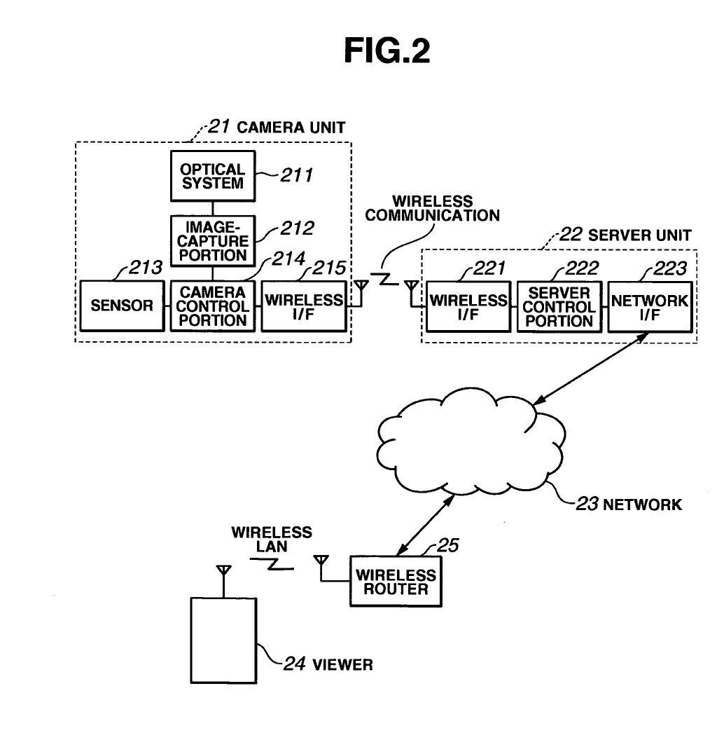

FIG. 2 shows an example in which data from a network 23, such as the Internet, is transmitted to a viewer 24 through wireless communication using a wireless router 25. Using the viewer 24 as unwired, a user can find a change in the monitored place wherever he is as long as radio waves reach the viewer 24.

In addition, a wireless portable terminal that is typified by a mobile phone using a wireless public network can be used as the viewer 24. In such a case, the user can find a change in the monitored place wherever he is within a coverage area of the mobile phone service. The function of a wireless router in that case may be performed by a network router, a telephone exchange, a wireless local station, etc., that belong to the telephone carrier.

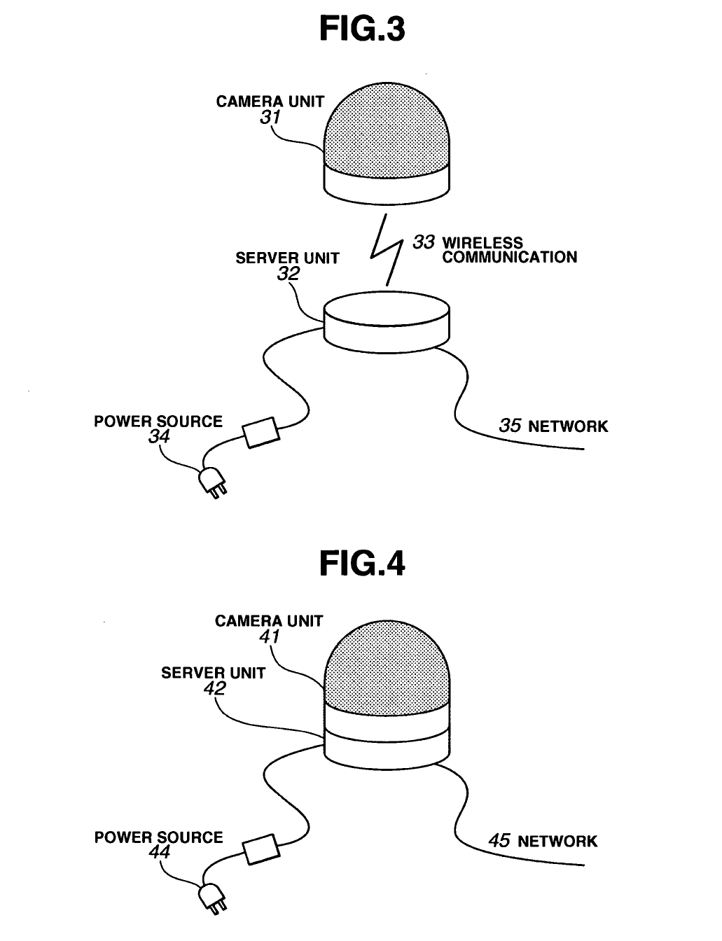

FIGS. 3 and 4 show examples of the arrangement of a camera unit and a server unit. FIG. 3 shows the case where the server unit 32 is separated from the camera unit 31 and wireless communication 33 is used between them. The camera unit 31 and the server unit 32 exchange data through wireless communication 33 and are, therefore, freely arranged and operated without the need for connection cables. To the server unit 32, a network 35 and a power source 34 are connected.

FIG. 4 shows the case where the camera unit 41 is mounted on the server unit 42. The camera unit 41 and the server unit 42 are connected by a connector, and communication and supply of power between them are performed through direct connection.

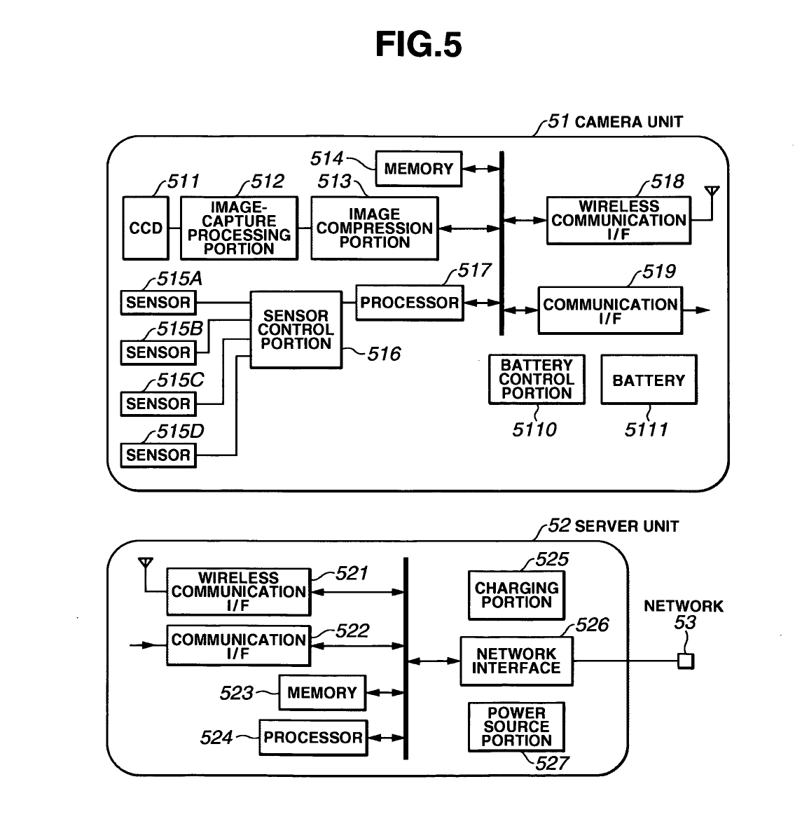

FIG. 5 is a block diagram showing in detail the construction of a camera unit 51 and a server unit 52 corresponding to those shown in FIGS. 1 to 4. The camera unit 51 includes a CCD (charge-coupled device) 511, an image-capture processing portion 512, an image compression portion 513, a memory 514, a plurality of sensors 515A to 515D, a sensor control portion 516, a processor 517, a wireless communication I/F 518, a communication I/F 519, a battery control portion 5110 and a battery 5111. The plurality of sensors 515A to 515D detect a change in circumstances surrounding the camera unit 51. The sensor control portion 516 drives the plurality of sensors 515A to 515D and outputs information on a direction in which an area where such a change has been detected exists, on the basis of output signals from the sensors 515A to 515D. The CCD 511 captures an image. The image-capture processing portion 512 provides control for the CCD 511, including focusing, aperture setting, white balance, etc. The image compression portion 513 compresses image data from the image-capture processing portion 512 using a compression method, such as JPEG and MPEG. The processor 517 receives compressed image data from the image compression portion 513 and detection signals from the sensor control portion 516 and transmits the received data to the wireless communication I/F 518 or the communication I/F 519. Further, the processor 517 extracts from the received image a partial image corresponding to the direction in which an area where the change has been detected exists. The memory 514 is used for processing by the processor 517. The wireless communication I/F 518 is used to transmit data to the server unit 52 wirelessly. The communication I/F 519 is used to transmit data to the server unit 52 where the server unit 52 is connected directly to the camera unit 51. The battery 5111 and the battery control portion 5110 serve as a power source where the camera unit 51 operates separately from the server unit 52 when wireless communication is employed.

The server unit 52 includes a wireless communication I/F 521, a communication I/F 522, a memory 523, a processor 524, a charging portion 525, a network interface 526 and a power source portion 527. The wireless communication I/F 521 receives data via wireless communication from the camera unit 51. The communication I/F 522 is used when the camera unit 51 is connected directly to the server unit 52. The processor 524 receives data from the wireless communication I/F 518 or the communication I/F 519, converts image data distorted by the solid-of-revolution mirror (optical system) into distortionless rectangular image data, and transmits the rectangular image data to the network interface 526. Further, the processor 524 functions as an image server on a network 53. The memory 523 is used for processing by the processor 524. The network interface 526 performs transmission and reception of data via the network 53. The charging portion 525 charges the battery 5111 of the camera unit 51 when the camera unit 51 is connected directly to the server unit 52. The power source portion 527 supplies electric power to the entirety of the server unit 52.

In the camera unit 51, electric power is normally supplied only to a very limited number of parts, such as the sensors 515A to 515D and the sensor control portion 516 for detecting a change in surrounding circumstances. The other parts are normally in a sleep mode so as to reduce power consumption of the battery 5111.

When at least one of the sensors 515A to 515D has detected a change in circumstances surrounding the camera unit 51, the whole camera unit 51 transitions from the sleep state to an operating state and instantaneously captures an omnidirectional image. The image compression portion 513 converts image data obtained by the CCD 511 and the image-capture processing portion 512 into compressed data in the JPEG or MPEG format. Then, the memory 514 stores the compressed data.

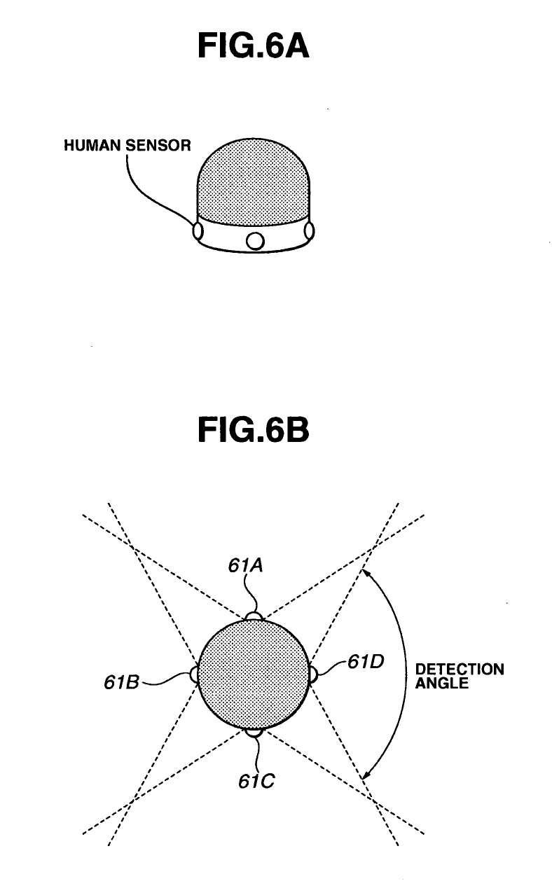

As an example of each of the sensors 515A to 515D, there is a pyroelectric motion sensor that detects a change in infrared rays emitted from a human body or the like. Since the pyroelectric motion sensor has the angular directivity of several tens of degrees, a plurality of sensors are required, as shown in FIG. 6A, to detect a change in circumstances of 360 degrees surrounding the camera unit 51.

FIG. 6B is a diagram showing the camera unit 51 as viewed from above. Four sensors 61A, 61B, 61C and 61D are mounted on the camera unit 51 to cover the omnidirectional detection range of 360 degrees by summing up detection angles of the four sensors.

The sensor control portion 516 detects a direction in which an area where a change has occurred exists, by determining which of the four sensors 61A to 61D (515A to 515D) has detected the change. If an increased number of sensors having finer directivity are used, the precision of detection of the direction can be increased.

As another example of each of the sensors 515A to 515D, an audio sensor using a microphone can also be used. In such a case, a plurality of audio sensors having directivity characteristics in the same manner as shown in FIGS. 6A and 6B are provided to cover the omnidirectional detection range of 360 degrees. In the case of the audio sensor, the signal output is generally an analog signal. Therefore, a rough direction can be detected by determining which of the plurality of sensors has detected the highest level signal. Further, higher-resolution detection of a direction can be performed by calculating the direction of a sound source through interpolation using a signal of the sensor detecting the highest level and a signal of the sensor detecting the second-highest level.

If infrared sensors typified by pyroelectric motion sensors and audio sensors typified by microphones are used in combination, detection of an intruder or the like can be performed more accurately.

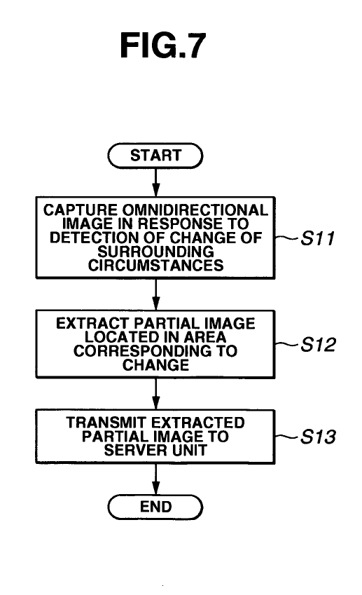

FIG. 7 is a flow chart illustrating the operation of the network camera system according to the first embodiment.

Referring to FIG. 7, at step S11, the sensor control portion 516 detects a change in surrounding circumstances and a direction in which an area where the change has occurred exists. In response to such detection, the image-capture processing portion 512 acquires an omnidirectional image. The memory 514 stores the acquired omnidirectional image. After that, at step S12, the processor 517 extracts, from the omnidirectional image stored in the memory 514, a partial image located in the area corresponding to the detected direction.

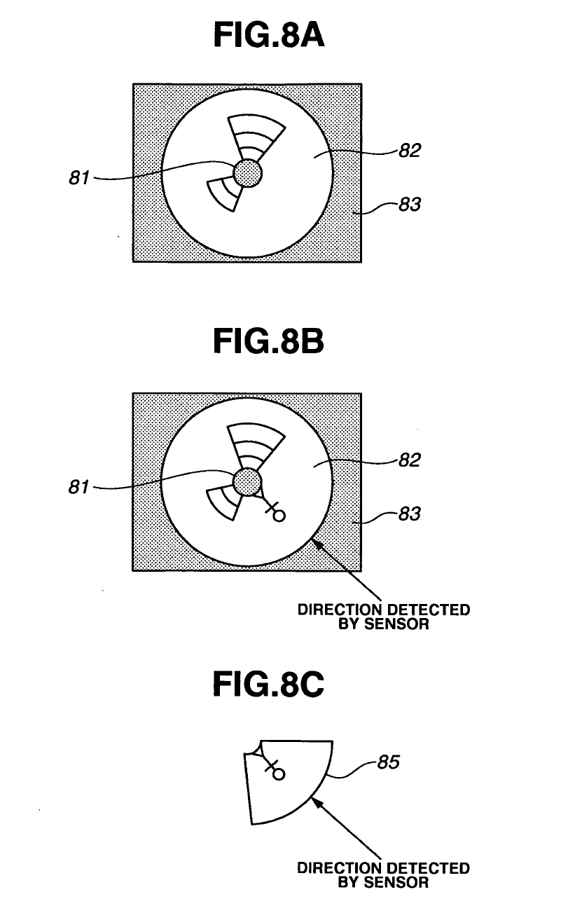

FIGS. 8A, 8B and 8C are diagrams illustrating an example of the extraction process. In FIGS. 8A and 8B, there are shown, in order from the center, an image 81 of the black needle portion, an image 82 of 360 degrees around, and an image 83 of the bottom surface of the solid-of-revolution mirror.

The processor 517 extracts a partial image located in an area centered in the direction detected by one of the sensors 515A to 515D. The extracted partial image is transmitted to the server unit 52 and is then subjected to processing for removing image distortion. Considering that the extracted partial image is displayed on the viewer after transmission via the network, it is appropriate to extract a fan-shaped image 85 as shown in FIG. 8C corresponding to, for example, the display aspect ratio 6:4 of the display device of the viewer.

At step S13, the processor 517 transmits the extracted partial image to the server unit 52 via the wireless communication I/F 518 or the communication I/F 519.

The wireless communication I/F 518 is used for transmission of the extracted partial image in cases where the camera unit 51 is used separately from the server unit 52 so as to allow the camera unit 51 to be freely disposed at any location. Electric power to the camera unit 51 is supplied from the battery 5111 via the battery control portion 5110. Thus, the camera unit 51 is used in a wireless condition.

In such a wireless condition, the camera unit 51 is driven with power of the battery 5111. Therefore, it is important to reduce power consumption of the camera unit 51. According to the extraction process described above, processing by the processor 517 required for extraction aims only at extraction of a fan-shaped image centered in the detected direction. Thus, a processor for use in a low-consumption portable device or the like suffices for such processing.

In cases where the camera unit 51 is directly connected to the server unit 52, the communication I/F 519 is used to transmit data to the server unit 52. The communication I/F 519 can use a variety of communication standards, for example, USB (universal serial bus), IEEE1394, etc.

These communication standards enable high-speed data communication as compared to wireless communication. Therefore, in the case of direct connection, a large amount of image data, such as a moving image, can be transmitted. Further, in the case of direct connection, the battery charging function is required to charge the battery 5111 inside the camera unit 51.

As described above, according to the first embodiment, the camera unit captures a surrounding image in response to detection timing of a plurality of sensors 61A to 61D having directivity for detecting a change in circumstances surrounding the camera unit and a direction in which an area where the change has occurred exists. The camera unit then extracts a partial image located in the area corresponding to the detected direction and transmits data of the extracted partial image to the network. Accordingly, observation from a remote location can be performed by simply placing the camera unit in an arbitrary monitoring position, for example, in the center of a room.

Furthermore, in addition to use of wireless communication, a battery is used as the power source of the camera unit, so that no connection cables are required. Accordingly, the freedom of placement of the camera unit increases dramatically, and specific work for installation of the camera unit is unnecessary. The aim of monitoring of circumstances can be achieved by simply placing the camera unit in an intended location when needed.

Furthermore, electric power is normally supplied only to the sensors to monitor the surrounding circumstances, and the whole camera unit is activated only when the sensors have detected a change in circumstances. In addition, the processing operation of the camera unit is simplified. Accordingly, low consumption is attained, and long-term monitoring of circumstances can be performed even with the battery-powered camera unit.

While, in the first embodiment, a system in which the camera unit is network-connected to the viewer via the server unit has been described, the system is not limited to such a construction. For example, the camera unit may be connected directly to a wireless public network, thereby making it possible to further increase locations where the camera unit can be placed.

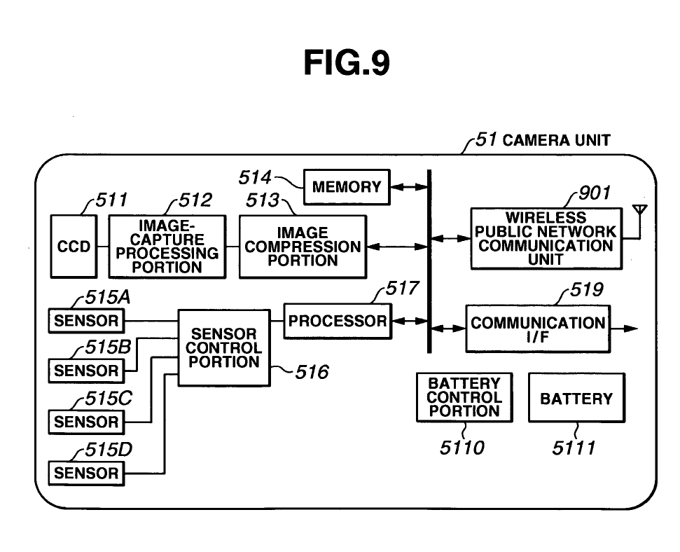

FIG. 9 shows the construction of the camera unit 51 that is connected directly to a wireless public network as mentioned above. The camera unit 51 includes, as a communication interface, a wireless public network communication unit 901 for connection to a wireless public network for mobile phones or PHS (personal handyphone system)

Change-indicating image data extracted from an image captured when a change in surrounding circumstances has been detected is transmitted directly to the wireless public network, and is then received by a viewer, such as a mobile phone, for display.

### Second Embodiment

A network camera system according to a second embodiment of the invention differs from the first embodiment in the method of detecting a change in circumstances and extracting a partial image.

In the network camera system according to the second embodiment, the hardware arrangement, the appearance of a camera unit and a server unit, the construction of the camera unit and the server unit, and the arrangement of sensors are the same as those of the first embodiment shown in FIG. 1 to FIGS. 6A and 6B, and are, therefore, omitted from the following discussion.

In the second embodiment, a surrounding image is captured at preset timing in the normal situation where there is no change. Then, the surrounding image is stored in the memory 514 shown in FIG. 5 as a comparative surrounding image. Such timing of capturing the surrounding image can be obtained, for example, by a method of capturing an image at intervals of a predetermined period of time with use of a timer.

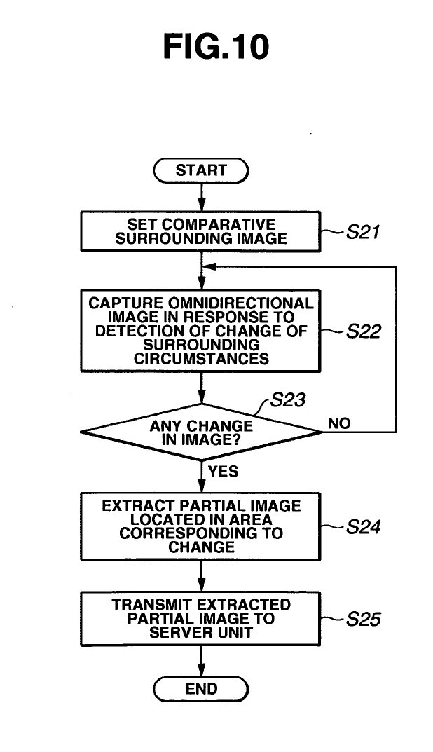

FIG. 10 is a flow chart illustrating the operation of the network camera system according to the second embodiment.

Referring to FIG. 10, at step S21, the processor 517 sets, as a comparative surrounding image, surrounding image data stored in the memory 514. At step S22, the processor 517 acquires image data captured in response to detection of a change in surrounding circumstances by the sensors 515A to 515D.

At step S23, the processor 517 compares the captured image data with the comparative surrounding image so as to determine if a change has occurred. The determination of whether a change has occurred uses a data value of each image area and determines whether the difference in the data values of each image area exceeds a predetermined threshold value. If it is determined that there is no change, the flow returns to step S22, where the processor 517 waits for detection by the sensors 515A to 515D.

If it is determined at step S23 that a change has occurred, the flow proceeds to step S24. At step S24, the processor 517 specifies pixels or blocks of pixels where the change has occurred and extracts a change-indicating partial image from the captured image on the basis of the specified pixels or blocks of pixels.

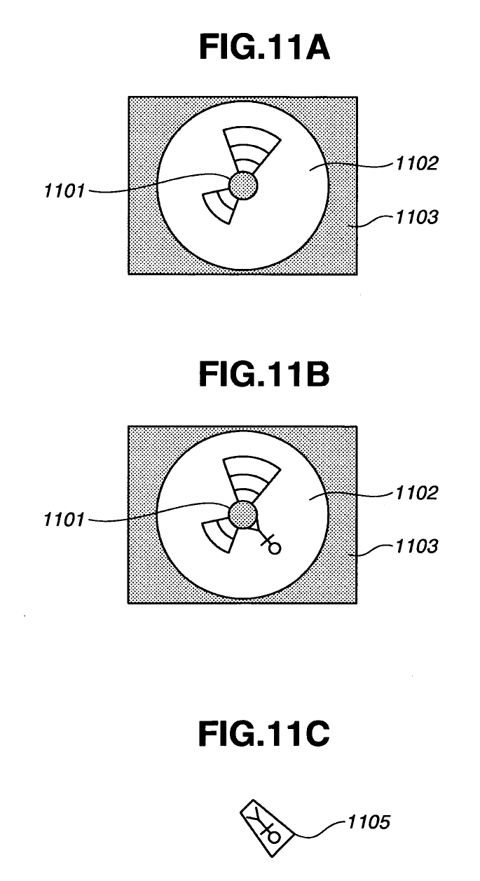

FIGS. 11A, 11B and 11C are diagrams illustrating an example of the extraction process. In FIGS. 11A and 11B, there are shown, in order from the center, an image 1101 of the black needle portion, an image 1102 of 360 degrees around, and an image 1103 of the bottom surface of the solid-of-revolution mirror. On the basis of a comparison between the comparative surrounding image (FIG. 11A) and the current image captured in response to detection by the sensors 515A to 515D (FIG. 11B), the processor 517 extracts apart 1105 shown in FIG. 11C as a change-indicating partial image.

Image data for use in detecting a change may be data obtained before image compression or data obtained after image compression.

At step S25, the processor 517 transmits the extracted partial image to the server unit 52 via the wireless communication I/F 518 or the communication I/F 519.

While, in the second embodiment, detection of a change in surrounding circumstances is performed by the sensors 515A to 515D, image data captured by the CCD 511 may be used to detect a change in surrounding circumstances.

In this case, the CCD 511, the image-capture processing portion 512, the image compression portion 513, the processor 517 and the memory 514 in the camera unit 51 are always kept in an operating state so as to capture a surrounding image continuously or at intervals of a short period in seconds. The processor 517 compares the currently-captured latest image data with the previously-captured image data and detects a change in surrounding circumstances by determining that a difference data value exceeds a predetermined threshold value.

### Third Embodiment

A network camera system according to a third embodiment of the invention differs from the first embodiment and the second embodiment in an image transmission process and an image display process.

In the network camera system according to the third embodiment, the hardware arrangement, the appearance of a camera unit and a server unit, the construction of the camera unit and the server unit, and the arrangement of sensors are the same as those of the first embodiment shown in FIG. 1 to FIGS. 6A and 6B, and are, therefore, omitted from the following discussion.

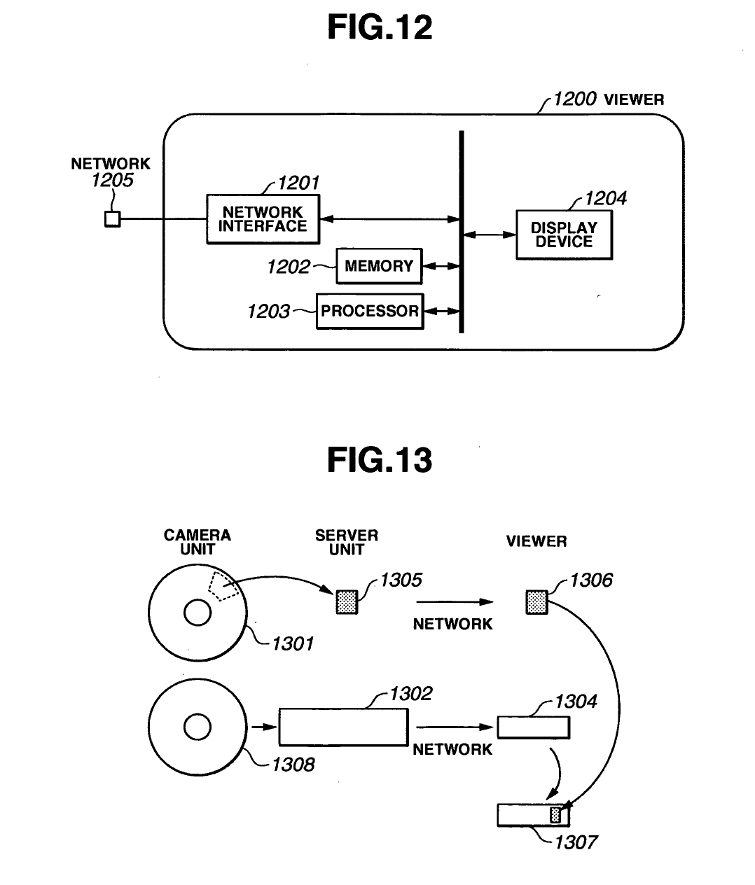

FIG. 12 is a block diagram showing in detail the construction of a viewer 1200 according to the third embodiment. The viewer 1200 is a portable device, such as a mobile phone or a personal digital assistant (PDA), and receives data from the server unit 52 via a network 1205. The viewer 1200 includes a network interface 1201, a memory 1202, a processor 1203 and a display device 1204. The network 1205 includes, but is not limited to, the Internet connected via a public wireless telephone line for use in mobile phones. Image data received from the server unit 52 via the network interface 1201 is processed by the memory 1202 and the processor 1203. Then, an image represented by the processed image data is displayed on the display device 1204.

Operation of the network camera system according to the third embodiment is described below with reference to FIGS. 5, 12 and 13.

FIG. 13 is a diagram illustrating an extraction process according to the third embodiment. In FIG. 13, an omnidirectional image 1308 is captured by the camera unit 51. The omnidirectional image 1308 is formed on the CCD 511 as a circular image by the optical system using the solid-of-revolution mirror. The server unit 52 receives the omnidirectional image 1308 in the shape of a circular image.

The server unit 52 converts the circular omnidirectional image 1308 into a rectangular image 1302, which is easy for an observer to recognize. The rectangular image 1302 is a horizontally long image with a resolution of 400×1600 pixels.

An image 1304 results from subjecting the rectangular image 1302 to reduction processing in accordance with the display resolution (for example, 120×160 pixels) of the small-sized display device 1204 of the viewer 1200.

An omnidirectional image 1301 is captured by the camera unit 51 when a change in surrounding circumstances has been detected by the sensors 515A to 515D. On the basis of a comparison between the omnidirectional image 1301 and the pre-captured normal omnidirectional image 1308, a change-indicating partial image in the form of a fan indicated by dotted lines is extracted by the camera unit 51.

A rectangular partial image 1305 is converted from the change-indicating partial image as extracted by the camera unit 51. The server unit 52 converts the fan-shaped partial image into the rectangular partial image 1305.

The server unit 52 transmits the rectangular partial image 1305 to the viewer 1200 via the network 1205. The viewer 1200 stores the rectangular partial image 1305 as an image 1306 having the same resolution.

An image 1307 is obtained by superimposing the change-indicating partial image 1306 on the reduced surrounding image 1304 after adjusting their resolution and positional relationship.

In order to acquire an omnidirectional image, a user first installs the camera unit 51 in a desired place, such as a room, to be monitored. After installation of the camera unit 51, the user performs an operation for starting a monitoring action. For example, the user turns on the power supply of the camera unit 51 and the server unit 52. The camera unit 51 causes the processor 517, etc., to produce a predetermined delay time from the timing of the turning-on of the power supply. After the elapse of the delay time, the camera unit 51 captures an omnidirectional image for one frame and sets it as a normal omnidirectional image 1308. Providing such a delay time makes it possible for a user who has placed the camera unit 51 to acquire a normal omnidirectional image having no image of the user himself captured.

Then, the camera unit 51 transmits the omnidirectional image 1308 to the server unit 52. After completion of this transmission, the camera unit 51 goes into a sleep state, i.e., a standby state. The server unit 52 converts the circular image 1308 into a rectangular image 1302 and stores the rectangular image 1302 in the memory 523. The resolution of the rectangular image 1302 is large compared with the display resolution of an ordinary mobile phone or the like (for example, 120×160 pixels) Therefore, the rectangular image 1302, if left as it is, can be displayed only in part on the mobile phone or the like. Accordingly, the server unit 52 performs a reduction process for converting the rectangular image 1302 into an image 1304 having a resolution coinciding with the vertical resolution of the display device 1204 of the viewer 1200 (for example, 120 Pixels).

The server unit 52 then transmits the reduced rectangular image 1304 to the viewer 1200 via the network 1205.

The viewer 1200 receives the reduced rectangular image 1304, stores it as a normal surrounding image in the memory 1204, and displays the normal surrounding image on the display device 1204. Such a function of displaying on the viewer 1200 a surrounding image obtained at the time of installation of the camera unit 51 makes it possible to inform the user of completion of the correct installation of the camera unit 51.

Furthermore, in this case, the user may be informed of completion of the installation of the camera unit 51 with characters displayed on the display device 1204 or sound produced by the viewer 1200 in addition to the displayed surrounding image.

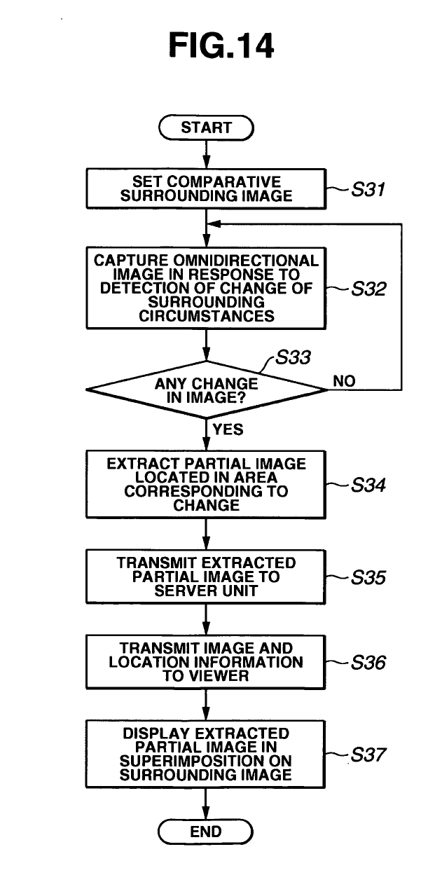

A method for displaying the reduced rectangular image on the viewer 1200 according to the third embodiment is described below with reference to FIGS. 12 to 15. FIG. 14 is a flow chart illustrating the image display method performed by the network camera system. In FIG. 14, steps S31 to S35 are controlled by the processor 517 of the camera unit 51. Step S36 is controlled by the processor 517 of the camera unit 51 and the processor 524 of the server unit 52. Step S37 is controlled by the processor 1203 of the viewer 1200.

At step S31, the processor 517 sets, as a comparative surrounding image, surrounding image data stored in the memory 514. This surrounding image data is, as described above, an image in a normal condition which has been captured at the time of installation of the camera unit 51. Then, the processor 517 waits for detection of a change in circumstances by the sensors 515A to 515D.

This surrounding image is initially used as a normal comparative image. In order to periodically detect a change in surrounding circumstances occurring with time, such a method may be employed that, for example, a timer is used to allow the camera unit 51 to capture an image at intervals of a predetermined period of time, and each captured image is used as a new normal surrounding image.

At step S32, when the sensors 515A to 515D have detected a change in circumstances surrounding the camera unit 51, the camera unit 51 comes into an operating state from the sleep state and instantaneously captures an omnidirectional image. Image data obtained by the CCD 511 is then stored in the memory 514 via the image-capture processing portion 512 and the image compression portion 513.

At step S33, the processor 517 compares the image data captured at the timing of detection by the sensor 515A to 515D with the comparative surrounding image to determine if a change has occurred with a data value of each image area exceeding a predetermined threshold value. If it is determined that there is no change, the flow returns to step S32, where the processor 517 waits for detection by the sensors 515A to 515D.

If it is determined at step S33 that a change has occurred, the flow proceeds to step S34. At step S34, the processor 517 specifies pixels or blocks of pixels where the change has occurred and extracts a change-indicating partial image from the captured image on the basis of the specified pixels or blocks of pixels.

As shown in FIG. 13, the processor 517 extracts only the fan-shaped change-indicating partial image from the omnidirectional image 1301. At step S35, the processor 517 transmits the extracted partial image to the server unit 52.

At step S36, the server unit 52 converts the extracted partial image into a rectangular image 1305 and transmits the rectangular image 1305 to the viewer 1200. When transmitting the extracted fan-shaped image to the server unit 52, the camera unit 51 additionally transmits information on the location of the extracted image relative to the omnidirectional image 1301. On the basis of this location information, the server unit 52 performs conversion into the rectangular image 1305. Further, when transmitting the rectangular image 1305 to the viewer 1200, the server unit 52 additionally transmits the location information.

The rectangular image 1305 is then stored in the memory 1202 of the viewer 1200 as a change-indicating partial image 1306 having the same resolution. The change-indicating partial image 1306 can be displayed on the display device 1204 without changing its resolution. However, the viewer 1200 forms an image 1307 by superimposing the change-indicating partial image 1306 on the reduced omnidirectional image 1304 after adjusting their resolution and positional relationship. At step S37, the viewer 1200 displays the combined image 1307 on the display deice 1204 which enables the user to more accurately recognize the surrounding circumstances.

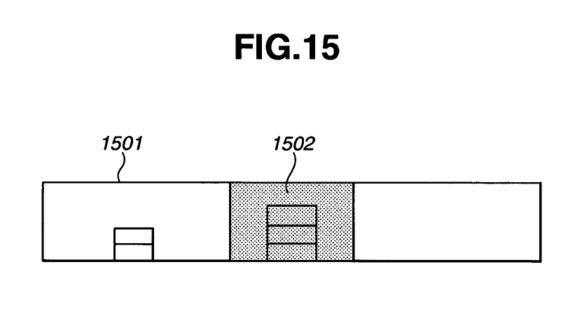

FIG. 15 is a diagram illustrating a method of displaying an image on the display device 1204 of the viewer 1200. As an example, the resolution 1502 of the display device 1204 may be a resolution of 120 pixels in the vertical direction and 160 pixels in the horizontal direction. An omnidirectional image 1501 is stored in the memory 1202 of the viewer 1200 after being subjected to a reduction process at the server unit 52 and being transmitted to the viewer 1200. The omnidirectional image 1501 is a horizontally long image as shown in FIG. 15. At the server unit 52, the vertical resolution of the omnidirectional image 1501 is made to coincide with the vertical resolution of 120 pixels of the display device 1204. Accordingly, the omnidirectional image 1501, which is transmitted to the viewer 1200 and displayed on the display device 1204, has such a relation as shown in FIG. 15 with respect to the resolution of the display device 1204. Therefore, when the user observes the omnidirectional image 1501 with the viewer 1200, simply scrolling the viewing area of the display device 1204 in the horizontal direction makes it easy to recognize the entirety of the omnidirectional image 1501.

FIGS. 16A to 16G are diagrams, illustrating the details of superimposition of images according to the third embodiment. FIG. 16A shows a normal omnidirectional image captured at the time of installation of the camera unit 51. The camera unit 51 transmits the captured omnidirectional image to the server unit 52 using wireless communication.

The server unit 52 converts the circular omnidirectional image as received to a rectangular image (FIG. 16B) that is easy to recognize. This rectangular image is subjected to a reduction process in accordance with the resolution of the display device 1204 of the viewer 1200. The reduced rectangular image is then transmitted to the viewer 1200 and stored therein.

FIG. 16C shows an image captured by the camera unit 51 when the sensors 515A to 515D have detected a change in surrounding circumstances. For example, the sensors 515A to 515D detect the movement of an intruder, and the camera unit 51 captures an omnidirectional image at that time.

The camera unit 51 compares the omnidirectional image captured at the time of detection by the sensors 515A to 515D (FIG. 16C) with the normal omnidirectional image (FIG. 16A) and finds a change-indicating part which indicates a difference between them. Then, the camera unit 51 extracts a fan-shaped image (FIG. 16D) corresponding to the change-indicating part from the omnidirectional image shown in FIG. 16C. The portion of an image to be extracted may be only a part where a minimum change has occurred (a part corresponding to a human body in the case of FIG. 16C), or may be an excessive area including the surrounding of a part where a change has occurred.

The camera unit 51 transmits the fan-shaped extracted image (FIG. 16D) to the server unit 52. The server unit 52 performs a rectangular conversion process for a partial image to convert the fan-shaped extracted image into a rectangular extracted image (FIG. 16E).

The server unit 52 transmits the rectangular extracted image (FIG. 16E) to the viewer 1200. The viewer 1200 displays the rectangular extracted image on the display device 1204. As shown in FIG. 16F, the rectangular extracted image displayed on the display device 1204 is large in size as its resolution is not changed. However, the rectangular extracted image corresponds only to a part where a change has occurred and does not include the surroundings of that part. Therefore, it may be difficult for a user to correctly determine in which position at the actual monitoring place the extracted image exists.

Therefore, the third embodiment provides the function of superimposing the rectangular extracted image on the normal omnidirectional image previously transmitted to the viewer 1200. As shown in FIG. 16G, the rectangular extracted image is displayed with its resolution and positional relationship adjusted with respect to the omnidirectional image. Thus, a change-indicating part is displayed in superimposition on a background.

As described above, according to the third embodiment, when a change in circumstances, for example, intrusion of a person, at a monitoring place is detected, only a partial image corresponding to the change included in a surrounding image captured at that time is transmitted to a display device via a network. At the display device, the partial image is displayed in superimposition on a normal surrounding image previously received. Accordingly, even with the use of a small display device with a resolution of 120×160 pixels mounted on a small-sized portable apparatus (for example, a portable communication terminal typified by a mobile phone), a user can accurately recognize the circumstances of the monitoring place.

Furthermore, when a camera unit is installed, a normal surrounding image having no image of a user himself is transmitted to a viewer and is displayed thereon. In addition, the user is informed of such transmission by the viewer. Accordingly, the user can confirm completion of steady installation of the camera unit.

### Fourth Embodiment

In the second and third embodiments, the comparative surrounding image stored in the memory 514 in the initial stage of a starting operation of the system is a surrounding image in a normal condition captured at the time of installation of the camera unit 51.

In a fourth embodiment of the invention, one of or a combination of two or more of the following timing defining methods (1) to (3) are employed to update the comparative surrounding image at any time in order to deal with a change in surrounding of the camera unit 51 occurring with time. In association with updating of the comparative surrounding image, a surrounding image stored in the memory 1204 of the viewer 1200 is also updated at any time in accordance with the same method.

(1) a timer or the like is used to cause the camera unit 51 to capture an image at intervals of a predetermined period of time, and each captured image is used as a new normal surrounding image.

(2) A user operates the viewer 1200 to transmit, to the camera unit 51 via the network 53 (1205) and the server unit 52, a command for capturing a new surrounding image so as to update the existing surrounding image.

(3) The camera unit 51 is provided with a luminance sensor for detecting surrounding luminance. When a predetermined change in luminance is detected by the luminance sensor, the camera unit 51 automatically updates the surrounding image. In addition, a capturing operation for the comparative surrounding image and the omnidirectional image at the time of detection of a change may be always accompanied by flash emission, carrying out both the function of capturing a clear image and the function of giving warning to an intruder.

The process based on each of the above methods (1) to (3) can be performed, for example, at step S21 shown in FIG. 10, step S31 shown in FIG. 14, etc.

### Fifth Embodiment

In the above-described embodiments, when an image display process is performed at the viewer 1200, the resolution of a surrounding image stored in the viewer 1200 may not coincide with that of an extracted image transmitted to the viewer 1200. In a fifth embodiment of the invention, a process for adjusting resolution is performed in accordance with one of the following methods (1) to (4) to appropriately display the extracted image in superimposition on the surrounding image.

(1) The surrounding image stored in the viewer 1200 is an image having a vertical resolution reduced to, for example, 120 pixels. Before the extracted image is transmitted from the server unit 52 to the viewer 1200, the server unit 52 performs, on the extracted image, a reduction process having the same reduction ratio as that of the surrounding image. After that, the server unit 52 transmits to the viewer 1200 the reduced, extracted image together with location information for superimposition.

(2) The server unit 52 transmits to the viewer 1200 the extracted image with its resolution kept unchanged without performing a reduction process on the extracted image. The viewer 1200 stores the extracted image. After that, the viewer 1200 performs on the stored, extracted image the same reduction process as that of the above method (1).

(3) The server unit 52 transmits to the viewer 1200 the extracted image with its resolution kept unchanged without performing a reduction process on the extracted image. The viewer 1200 stores the extracted image. After that, in cases where a user intends to display the stored, extracted image in a given size, the viewer 1200 performs a magnifying/reduction process on the extracted image, and also performs a magnifying/reduction process on the surrounding image stored in the viewer 1200 at an optimum magnifying/reduction ratio with respect to the whole of the surrounding image or its part displayed on the viewer 1200.

(4) In cases where the surrounding image is magnified in a large size as a result of the magnifying/reduction process performed in accordance with the above method (3) although the resolution of the surrounding image stored in the viewer 1200 is low as compared with the extracted image, the surrounding image may be blurred due to a pixel interpolation process associated with the magnifying process. To solve this problem, with regard to a part of the surrounding image displayed on the viewer 1200, after displaying the blurred surrounding image, the viewer 1200 requests the server unit 52 to transmit a surrounding image not yet subjected to the reduction process, receives such a higher-resolution surrounding image, and replaces the existing surrounding image with the higher-resolution surrounding image having the same resolution as that of the extracted image.

The process based on each of the above methods (1) to (4) can be performed, for example, at step S36 and step S37 shown in FIG. 14, etc.

### Sixth Embodiment

In the above-described embodiments, only one image is captured when a change in circumstances has been detected. Therefore, it is only possible to recognize a stationary state of an object causing such a change. In a sixth embodiment of the invention, a continuous shooting operation of the camera unit 51 and a continuous displaying operation of the viewer 1200 are provided to make it also possible to recognize the movement of an object.

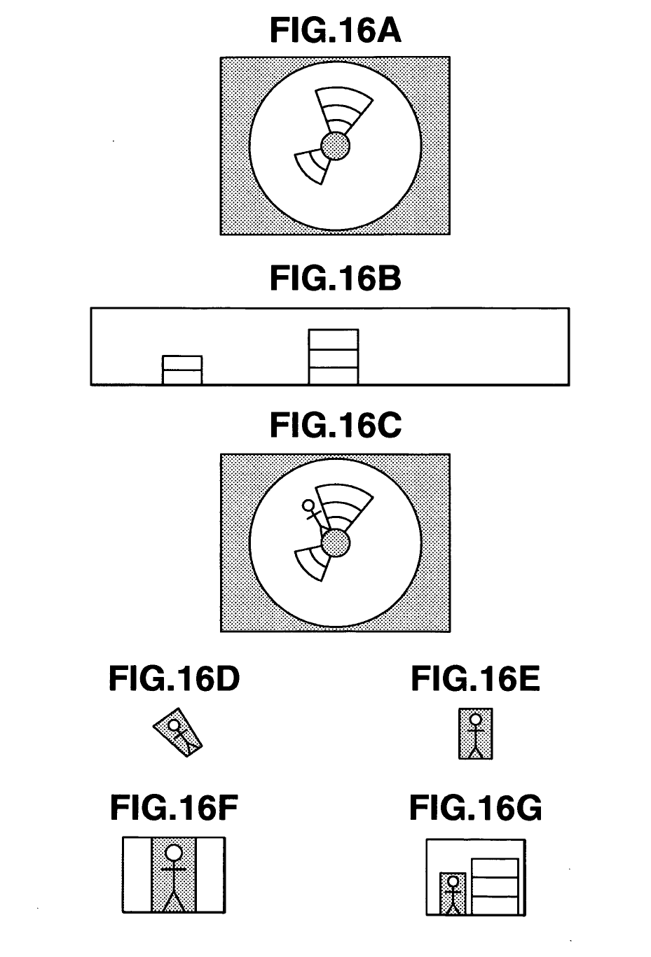

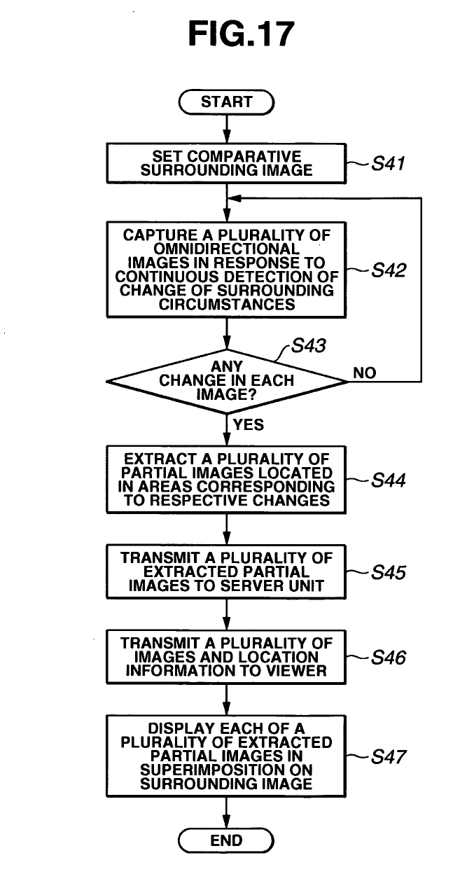

A method for displaying a reduced rectangular image on the viewer 1200 according to the sixth embodiment is described below with reference to FIG. 17. FIG. 17 is a flow chart illustrating the image display method performed by the network camera system according to the sixth embodiment. In FIG. 17, steps S41 to S45 are controlled by the processor 517 of the camera unit 51. Step S46 is controlled by the processor 517 of the camera unit 51 and the processor 524 of the server unit 52. Step S47 is controlled by the processor 1203 of the viewer 1200.

On the viewer 1200 according to the sixth embodiment, an image is displayed in the same manner as shown in FIG. 15. Therefore, when a user observes the omnidirectional image 1501 with the viewer 1200, simply scrolling the viewing area of the display device 1204 in the horizontal direction makes it easy to recognize the entirety of the omnidirectional image 1501.

At step S41, the processor 517 sets, as a comparative surrounding image, surrounding image data stored in the memory 514. This surrounding image data is, as described above, an image in a normal condition which has been captured at the time of installation of the camera unit 51. Then, the processor 517 waits for detection of a change in circumstances by the sensors 515A to 515D.

At step S42, when the sensors 515A to 515D have detected a change in circumstances surrounding the camera unit 51, the camera unit 51 enters into an operating state from the sleep state and instantaneously captures the first omnidirectional image. After that, if the sensors 515A to 515D have continuously detected a change in the surrounding circumstances for a continuous period of time, the camera unit 51 captures a plurality of omnidirectional images in series, for example, at intervals of a given period during the detection period. Image data for a plurality of captured omnidirectional images are then sequentially stored in the memory 514 via the image-capture processing portion 512 and the image compression portion 513.

At step S43, the processor 517 compares the image data for each of a plurality of omnidirectional images captured at the timing of detection by the sensor 515A to 515D with the comparative surrounding image to determine if a change has occurred with a data value of each image area exceeding a predetermined threshold value. If it is determined that there is no change, the flow returns to step S42, where the processor 517 waits for detection by the sensors 515A to 515D.

If it is determined at step S43 that a change has occurred, the flow proceeds to step S44. At step S44, the processor 517 specifies pixels or blocks of pixels where the change has occurred and extracts change-indicating partial images from the captured image on the basis of the specified pixels or blocks of pixels. Thus, the processor 517 produces a plurality of extracted partial images.

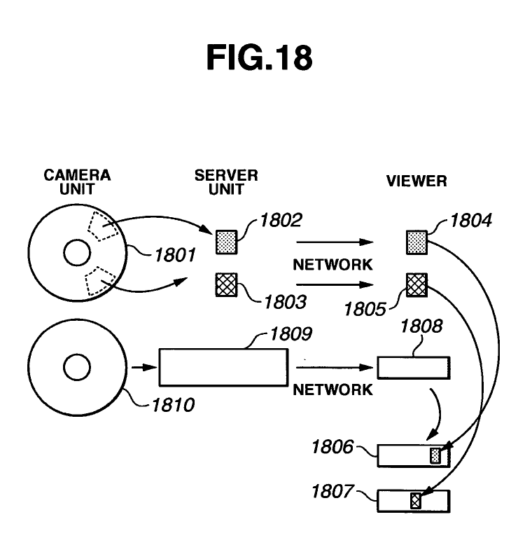

FIG. 18 is a diagram illustrating an extraction process according to the sixth embodiment, taking an example in which two images of a plurality of extracted partial images obtained when the sensors 515A to 515D have detected a plurality of changes are processed. As shown in FIG. 18, the processor 517 extracts a plurality of fan-shaped change-indicating partial images from an omnidirectional image 1801. At step S45, the processor 517 transmits the extracted partial images to the server unit 52.

At step S46, the server unit 52 converts the extracted partial images into rectangular images 1802 and 1803 and transmits the rectangular images 1802 and 1803 to the viewer 1200. When transmitting the extracted fan-shaped image to the server unit 52, the camera unit 51 additionally transmits information about the location of the extracted image relative to the omnidirectional image 1801. On the basis of this location information, the server unit 52 performs conversion into a rectangular image. Further, when transmitting the rectangular image to the viewer 1200, the server unit 52 additionally transmits the location information. The above-described process is sequentially performed for each of a plurality of omnidirectional images captured at the timing of detection of changes.

At step S47, the viewer 1200 forms and displays each of a plurality of images 1806 and 1807 by superimposing each of a plurality of change-indicating partial images 1804 and 1805 on a reduced omnidirectional image 1808 after adjusting their resolution and positional relationship.

The plurality of images 1806 and 1807 each having a superimposed partial image are displayed sequentially over time, so that a user can accurately recognize the surrounding circumstances including the movement of an object. In this instance, such a sequential displaying operation may be performed in sequence in accordance with timing of receiving extracted images from the server unit 52, or may be performed in order after the viewer 1200 receives a series of change-indicating partial images.

In the initial stage of a starting operation of the system, the comparative surrounding image stored in the memory 514 is a surrounding image in a normal condition captured at the time of installation of the camera unit 51. After that, the comparative surrounding image may be updated at any time in accordance with one of the methods (1) to (3) described in the fourth embodiment.

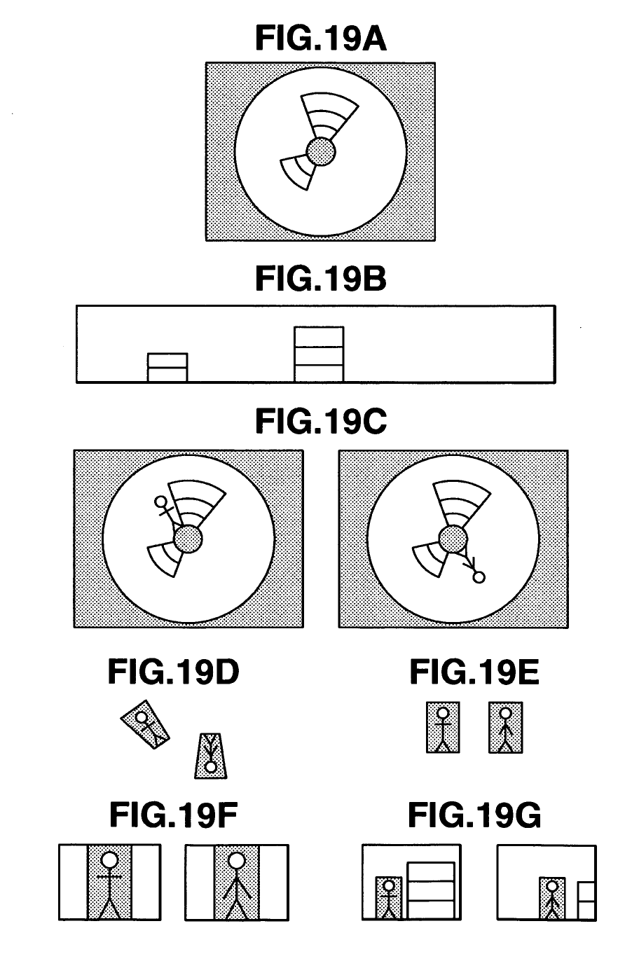

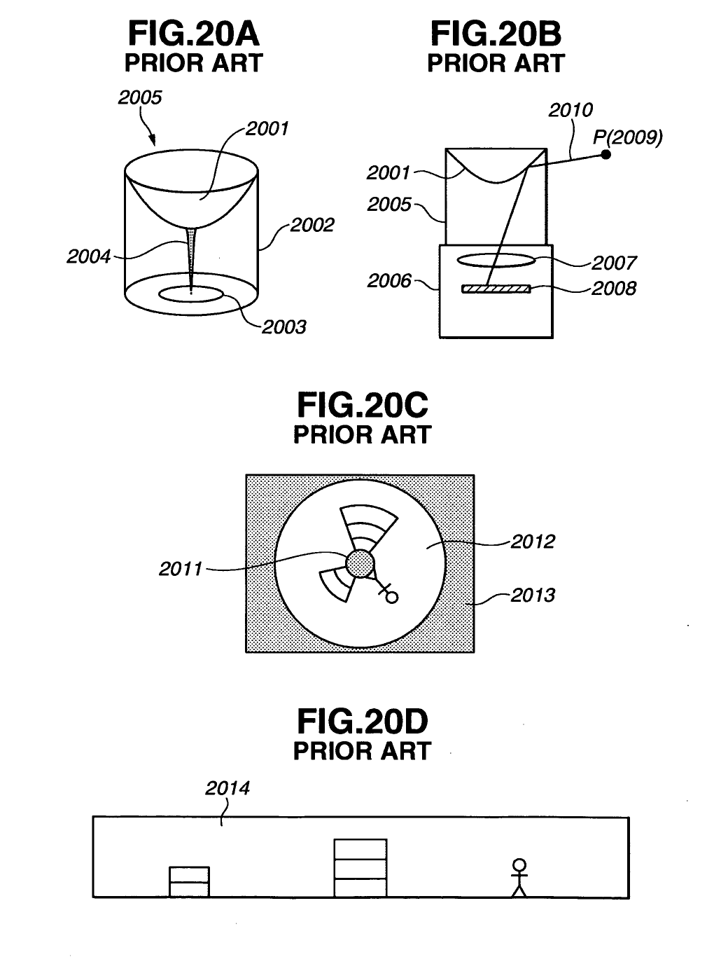

FIGS. 19A to 19G are diagrams illustrating the details of superimposition of images according to the sixth embodiment. FIG. 19A shows a normal omnidirectional image captured at the time of installation of the camera unit 51. The camera unit 51 transmits the captured omnidirectional image to the server unit 52 using wireless communication.

The server unit 52 converts the circular omnidirectional image received to a rectangular image (FIG. 19B) that is easy to recognize. This rectangular image is subjected to a reduction process in accordance with the resolution of the display device 1204 of the viewer 1200. The reduced rectangular image is then transmitted to the viewer 1200 and stored therein as a comparative surrounding image.

FIG. 19C shows images captured by the camera unit 51 when the sensors 515A to 515D have detected a change in surrounding circumstances. For example, the sensors 515A to 515D detect the movement of an intruder, and the camera unit 51 captures omnidirectional images at that time. If, after that, the sensors 515A to 515D have continuously detected a change in surrounding circumstances, the camera unit 51 continuously performs a continuous shooting operation to capture omnidirectional images, for example, at intervals of 1 second during the detection period.

The camera unit 51 compares each of a plurality of (n=2 in the case of FIG. 19C) omnidirectional images captured at the time of detection by the sensors 515A to 515D (FIG. 19C) with the normal omnidirectional image (FIG. 19A) and finds change-indicating parts each of which indicates a difference between them. Then, the camera unit 51 extracts fan-shaped images (FIG. 19D) corresponding to the change-indicating parts from the omnidirectional images shown in FIG. 19C. Thus, the camera unit 51 produces a plurality of (n) extracted partial images. The range of an image to be extracted may be only a part where a minimum change has occurred (a part corresponding to a human body in the case of FIG. 19C), or may be an excessive area including the surrounding of a part where a change has occurred.

The camera unit 51 transmits n fan-shaped extracted images (FIG. 19D) to the server unit 52. The server unit 52 performs a rectangular conversion process for a partial image to convert the n fan-shaped extracted images into n rectangular extracted images (FIG. 19E). Then, the server unit 52 transmits the n rectangular extracted images (FIG. 19E) to the viewer 1200.

If the viewer 1200 displays the rectangular extracted images as shown in FIG. 19F, only partial images corresponding to areas where a change has occurred are displayed and the associated surrounding image is not displayed. Therefore, it may be difficult for a user to correctly determine in which position at the actual monitoring place the displayed image exists.

To solve this problem, the viewer 1200 produces n images as shown in FIG. 19G by superimposing each extracted image on the stored comparative surrounding image after adjusting their image size and positional relationship.

The viewer 1200 sequentially displays the n images each having a superimposed partial image which enables a user to correctly recognize the surrounding images while monitoring the movement of a target object.

In this instance, the resolution of a surrounding image stored in the viewer 1200 may not necessarily coincide with that of an extracted image (FIG. 19E) transmitted to the viewer 1200. Therefore, in the sixth embodiment, a process for adjusting resolution can also be performed in the same manner as described in the fifth embodiment so as to produce images as shown in FIG. 19G.

As described above, according to the sixth embodiment, when a change in circumstances, for example, intrusion of a person, at a monitoring place is detected, only partial images corresponding to the change included in a surrounding image captured at that time are transmitted as frame-advance images to a display device via a network. At the display device, the partial images are sequentially displayed in superimposition on a normal surrounding image previously received. Accordingly, even with the use of a small display device with a resolution of 120×160 pixels mounted on a small-sized portable apparatus (for example, a portable communication terminal typified by a mobile phone), a user can accurately recognize the circumstances of the monitoring place.

Furthermore, when a camera unit is installed, a normal surrounding image having no image of a user himself is transmitted to a viewer and is displayed thereon. In addition, the user is informed of such transmission by the viewer. Accordingly, the user can confirm completion of steady installation of the camera unit.

### Other Embodiments

The present invention can also be achieved by providing a system or apparatus with a storage medium that stores program code of software for realizing the functions of the above-described embodiments, and causing a computer (or a CPU (central processing unit), MPU (micro-processing unit) or the like) of the system or apparatus to read the program code from the storage medium and then to execute the program code.

In this case, the program code itself read from the storage medium realizes the functions of the embodiments.

In addition, the storage medium for providing the program code includes a flexible disk, a hard disk, an optical disk, a magneto-optical disk, a CD-ROM (compact disk—read-only memory), a CD-R (compact disk—recordable), a CD-RW (compact disk—rewritable), a DVD-ROM (digital versatile disk—read-only memory), a DVD-RAM (digital versatile disk—random-access memory), a DVD-RW (digital versatile disk—rewritable), a DVD-R (digital versatile disk—recordable), a magnetic tape, a non-volatile memory card, a ROM (read-only memory), etc.

Furthermore, besides the program code read by the computer being executed to realize the functions of the above-described embodiments, the present invention includes an OS (operating system) or the like running on the computer performing an actual process in whole or in part according to instructions of the program code to realize the functions of the above-described embodiments.

Moreover, the present invention also includes a CPU or the like contained in a function expansion board inserted into the computer or in a function expansion unit connected to the computer, the function expansion board or the function expansion unit having a memory in which the program code read from the storage medium is written, the CPU or the like performing an actual process in whole or in part according to instructions of the program code to realize the functions of the above-described embodiments.

The invention has been described in detail with particular reference to exemplary embodiments thereof, but it will be understood that variations and modifications can be effected within the scope of the invention as described above, and as noted in the appended claims, by a person of ordinary skill in the art without departing from the scope of the invention.

1. An image processing apparatus for processing an image captured by a camera, the image processing apparatus comprising:
a detection device for detecting a change in circumstances surrounding the camera;
an acquisition device for acquiring an image captured by the camera in response to detection by the detection device;
an extraction device for extracting, from the captured image, a partial image corresponding to an area in which the change in circumstances occurred; and
an output device for outputting the partial image extracted by the extraction device.

2. An image processing apparatus according to claim 1, wherein the detection device for detecting a change in circumstances surrounding the camera includes one of an optical sensor, an audio sensor, a temperature sensor, and a combination thereof.

3. An image processing apparatus according to claim 1, wherein the camera includes a wide-angle image-capture system, and the acquisition device acquires an image captured by the wide-angle image-capture system.

4. An image processing apparatus according to claim 1, wherein the camera includes an omnidirectional camera using a solid-of-revolution mirror, and the acquisition device acquires an image captured by the omnidirectional camera.

5. An image processing apparatus according to claim 1, wherein the output device includes a transmission device for transmitting the extracted partial image to an external apparatus having network connection capability.

6. An image processing apparatus according to claim 1, further comprising:
a battery power source device for supplying power from a battery; and
an external power source device for supplying power from an external apparatus,
wherein one of the battery power source device and the external power source device is selectively usable.

7. An image processing apparatus according to claim 1, wherein the output device includes a wireless transmission device for wirelessly transmitting the extracted partial image to an external apparatus.

8. An image processing apparatus according to claim 1, wherein the detection device includes a plurality of sensors having respective detecting directions assigned thereto, and the extraction device extracts a partial image located in an area corresponding to the detecting direction of each of the plurality of sensors.

9. An image processing apparatus according to claim 1, wherein the extraction device compares a previously-stored surrounding image to a captured image acquired by the acquisition device and extracts a partial image located in an area where a result of the comparison indicates that a change has occurred.

10. An image processing apparatus according to claim 1, wherein the camera is configured integrally with the image processing apparatus.

11. A network camera system for displaying an image captured by a camera, the network camera system comprising:
a detection device for detecting a change in circumstances surrounding the camera;
an acquisition device for acquiring an image captured by the camera in response to detection by the detection device;
an extraction device for extracting, from the captured image, a partial image corresponding to an area in which the change in circumstances occurred;
a transmission device for transmitting the partial image extracted by the extraction device to a network; and
a display device for displaying the extracted partial image transmitted from the transmission device.

12. A network camera system according to claim 11, wherein, before transmitting the extracted partial image, the transmission device applies a resolution conversion process to the extracted partial image to make a resolution thereof based on a display resolution of the display device.

13. A network camera system according to claim 11, wherein the transmission device previously transmits a surrounding image captured by the camera to the display device, and the display device displays the extracted partial image in superimposition on the surrounding image.

14. A network camera system according to claim 13, wherein the transmission device performs transmission of the surrounding image at the time of installation of the camera, and the display device displays completion of storage of the surrounding image.

15. A network camera system according to claim 13, wherein, before transmitting the surrounding image, the transmission device applies a resolution conversion process to the surrounding image to reduce data size thereof, and the display device performs a process for matching a resolution of the surrounding image with that of the extracted partial image and displays the processed surrounding image and extracted partial image.

16. A network camera system according to claim 13, wherein, if the detection device has continuously detected changes in circumstances surrounding the camera, the extraction device produces a plurality of extracted partial images corresponding to areas in which the respective changes in circumstances have occurred, and the transmission device transmits the plurality of extracted partial images.

17. A network camera system according to claim 16, wherein the display device sequentially displays each of the plurality of extracted partial images in superimposition on the surrounding image.

18. A network camera system according to claim 11, wherein the network camera system comprises a camera unit including the camera, the detection device, the acquisition device and the extraction device, a server unit including the transmission device, and a viewer including the display device.

19. An image processing method for processing an image captured by a camera, the image processing method comprising:
detecting a change in circumstances surrounding the camera;
acquiring a captured image using the camera in response to detection of the change in circumstances;
extracting, from the captured image, a partial image corresponding to an area in which the change in circumstances occurred; and
outputting the partial image extracted.

20. A program for performing an image processing method according to claim 19.

21. A computer-readable medium including computer-readable instructions for performing a method according to claim 19.
